(19) United States
(12) Patent Application Publication
(10) Pub. No.: US 2010/0264182 A1
(43) Pub. Date: Oct. 21, 2010

(54) Cell Phone Holder

(75) Inventors: Leslie Perlman, New York, NY (US); Seth Goldberg, New York, NY (US)

Correspondence Address: Kane Kessler P.C., 1350 Avenue of the Americas, 26th Floor, New York, NY, 10019, US

(73) Assignee: GOLDPERL, LLC, New York, NY (US)

(21) Appl. No.: 12/764,404

(22) Filed: Apr. 21, 2010

Related U.S. Application Data
(60) Provisional application No. 61/171,230, filed on Apr. 21, 2009.

(51) Int. Cl. B60R 7/00

(52) U.S. Cl. 224/409

(57) ABSTRACT

A holder for holding a phone on a support structure such as a handlebar of a stroller includes a mount for releasable connection with the support structure. A base is supported on the mount for receiving and supporting the phone. A slider is supported on the base for sliding movement relative to the base between a first position enabling removal of the phone from the holder and at least one clamping position blocking removal of the phone from the holder.

### RELATED APPLICATIONS

This application claims the benefit of the filing date of U.S. Provisional Patent Application No. 61/171,230, filed Apr. 21, 2009, the entire disclosure of which is incorporated by reference.

### BACKGROUND OF THE INVENTION

This invention relates to a device for temporarily mounting a cell phone or smartphone to a support structure such as a handlebar of, for example, a stroller, treadmill, bicycle, or elliptical exercise machine.

### BRIEF DESCRIPTION OF THE DRAWINGS

FIG. 1 is a perspective view of a cell phone holder that is a first embodiment of the invention, shown in full lines in an assembled condition, and showing in phantom the slider in a disassembled condition;

FIG. 2 is an exploded perspective view of the cell phone holder of FIG. 1 shown in a disassembled condition;

FIG. 3A is an exploded perspective view of a base and a mount that form part of the cell phone holder of FIG. 1;

FIG. 3B is another an exploded perspective view of the base and the mount that form part of the cell phone holder of FIG. 1;

FIG. 3C is a bottom plan view of the base and mount in an assembled condition, taken generally along the line 3C-3C of FIG. 3B;

FIG. 4A is an exploded perspective view of a base and a slider that form part of the cell phone holder of FIG. 1;

FIG. 4B is another perspective view of the slider;

FIG. 5A is a front elevational view of the assembled cell phone holder of FIG. 1 with the slider shown in a first locking position on the base;

FIG. 5B is a side elevational view taken generally along the line 5B-5B of FIG. 5A;

FIG. 5C is a front elevational view of the assembled cell phone holder of FIG. 1 with the slider shown in a second locking position on the base;

FIG. 5D is a side elevational view taken generally along the line 5D-5D of FIG. 5C;

FIG. 6A is an enlarged rear fragmentary view of the slider and base; and

FIG. 6B is a sectional view of the slider and base in the position shown in FIG. 6A.

### DETAILED DESCRIPTION

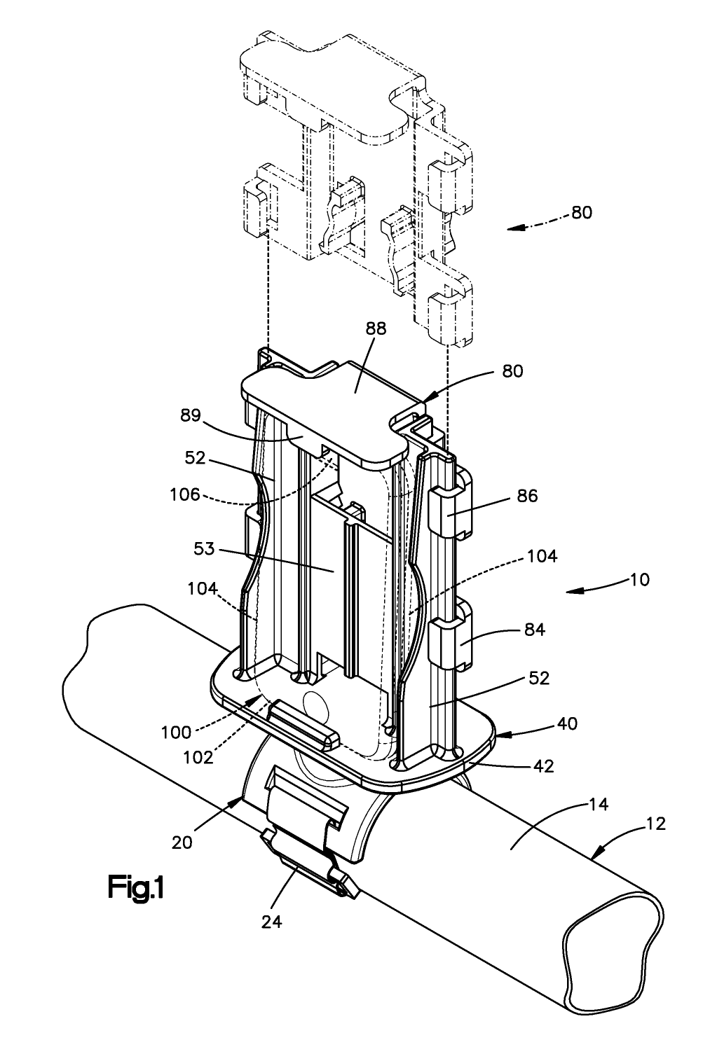

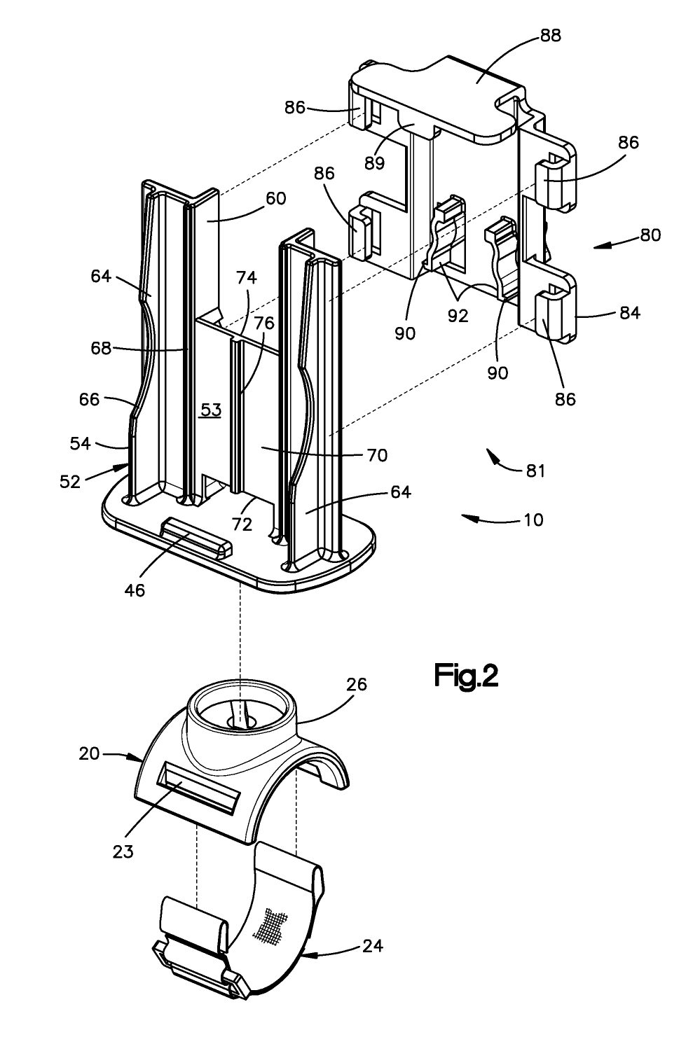

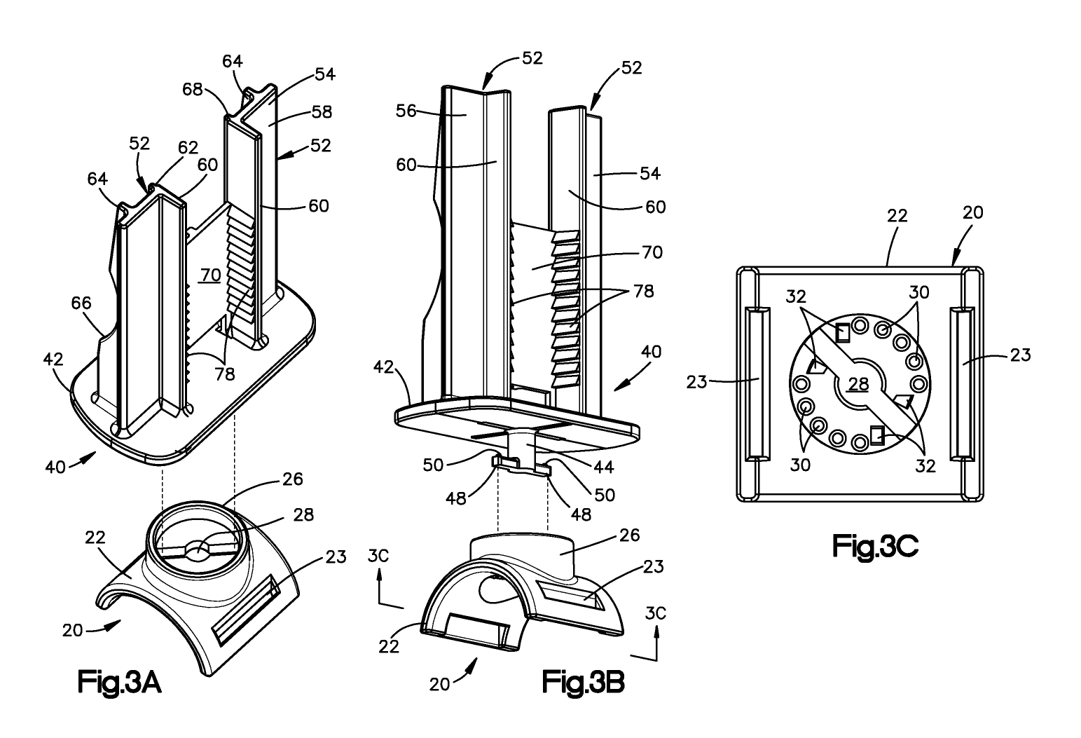

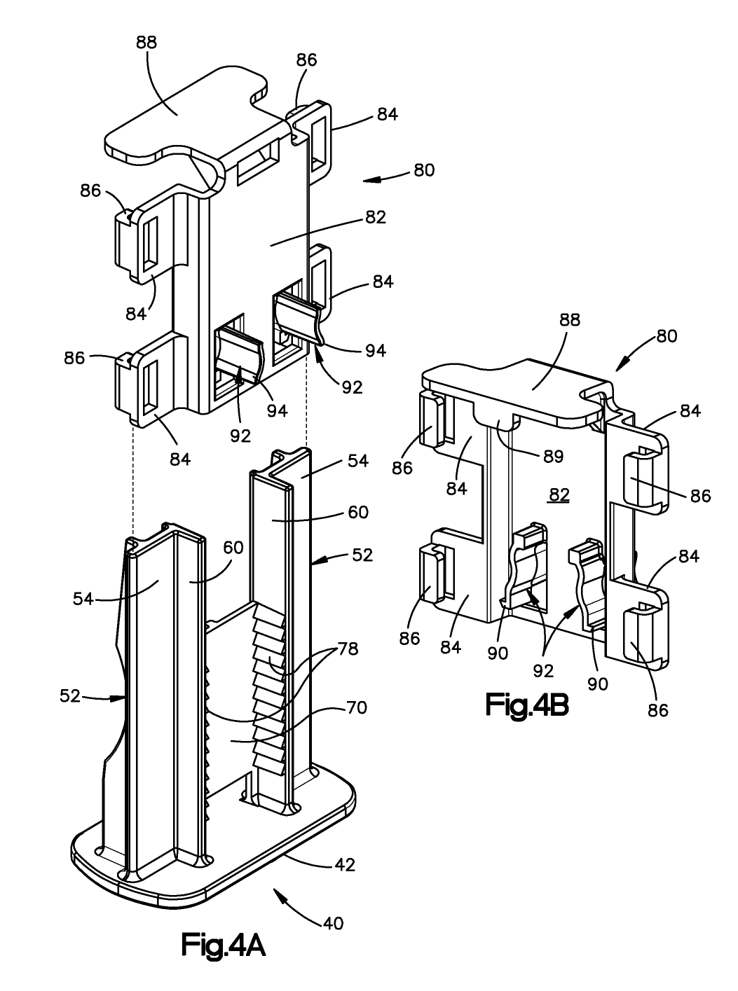

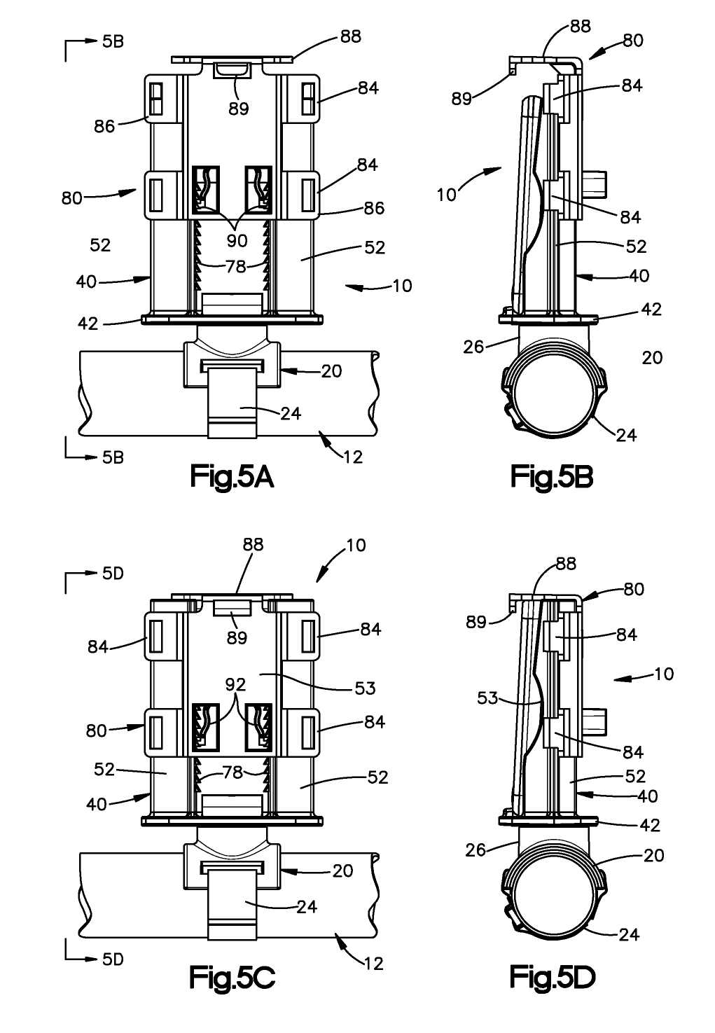

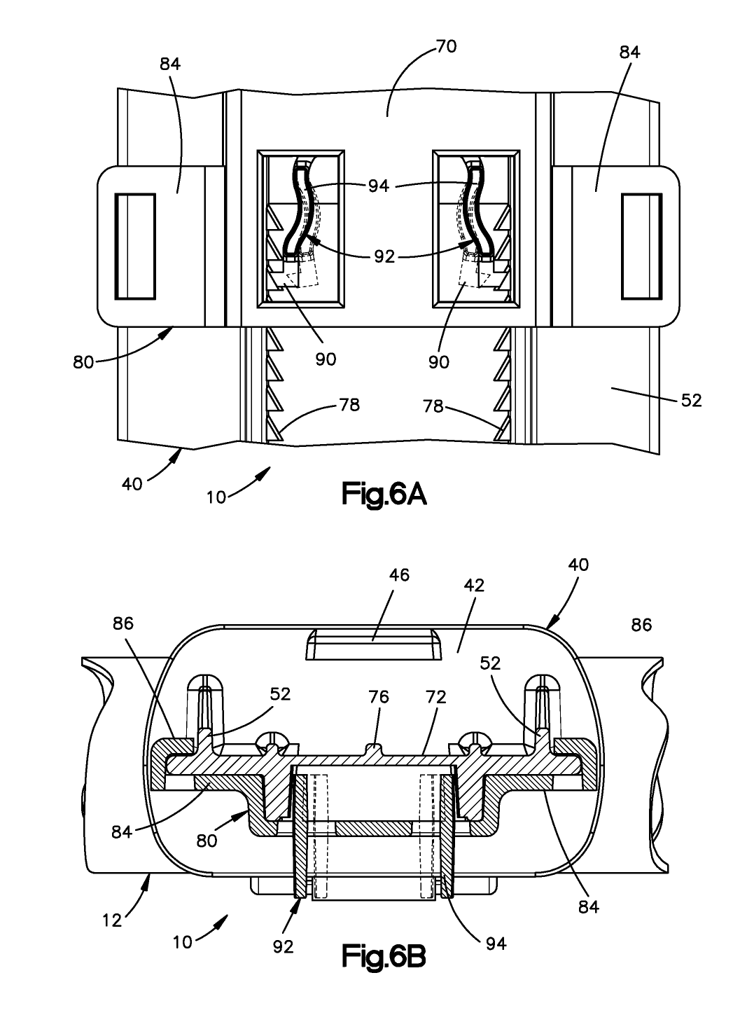

The present invention is applicable to cell phone holders of different configurations, and also to holders for smartphones, etc. As representative of the invention, FIG. 1 illustrates a phone holder 10 that is a first embodiment of the invention.

The phone holder 10 is adapted to be mounted to or supported on a structure such as the handlebar 12 of a stroller, wheelchair, shopping cart, etc. Such a handlebar 12 typically has a round cross-sectional configuration with a curved outer surface 14. The holder 10 can be configured to be supported on other types of structures. The holder 10 is applicable to secure cell phones, smartphones, or other devices, such as an MP3 player, IPod, GPS device, or other portable electronic device. In this application, the term “phone” is used to represent any and all of these types of devices.

The holder 10 includes three major pieces, preferably made from molded plastic, which are interconnected as described below to form the holder. The three pieces are a mount 20, which attaches to the handlebar 12 and supports the other pieces; a base 40, which attaches to the mount and is the primary support for the phone 42; and a slider 80, which slidably attaches to the base and holds the phone in position on the base. The base 40 and the slider 80, together, constitute a two-piece clamp assembly 81 that is supported on the mount 20, and that clamps the phone in place on the holder 10, as described below.

The mount 20 attaches directly to the handlebar 12. The mount 20 has a curved lower portion 22 that wraps around and engages the curved outer surface 14 of the handlebar 12, so that it sits atop the handlebar. The mount 20 has two slots 23 through which a retaining strap 24 is threaded. The retaining strap 24 could be a Velcro strap, for example. The strap 24 extends about the handlebar 12 and secures the mount 20, and thus the entire holder 10, to the handlebar. The holder 10 can easily be adapted to fit handlebars or supporting structures with other configurations, by providing a mount with a different configuration.

The mount 20 has an upper portion or socket 26 having a pin opening 28. The pin opening 28 is adapted to receive a locking pin of the base 40, as described below. The socket 26 has a flat detent surface 28 on its underside in which are formed a plurality of detents 30 shaped as part-spherical recesses. The recesses 30 are disposed in a circular array centered on the pin opening 28. The mount 20 also includes two stop elements 32.

The base 40 includes a lower plate 42 for attachment to the mount 20. A lip 46 is located at the front edge of the lower plate 42. A locking pin 44 projects downward from the lower plate 42. The locking pin 44 is adapted to lock into the locking pin opening 28 in the mount 20, in a manner so as to prevent inadvertent removal of the base 40 from the mount. The base 40 also includes two stops 48 that are engageable with the stop surfaces 32 on the mount 20, as described below, as well as two detent pins 50.

The base 40 includes two main posts 52 that project upward from the lower plate 42. The two posts 52 are mirror images of each other, on opposite sides of a phone-receiving space 53 of the holder 10. Each post 52 is generally L-shaped in cross-sectional configuration. The L-shaped configuration includes a first leg 54 that extends in a direction from side to side on the base 40. The first leg 54 has a front surface 56 and a back surface 58.

The post 52 also includes a second leg 60 that projects from the back surface 58 of the first leg 54 in a direction perpendicular to the first leg. The second leg 60 is located at the inner edge 62 of the first leg 52.

The post 52 also includes a third leg 64 that projects forward from the front surface 56 of the first leg 54, near the outer edge 66 of the first leg. In addition, the third leg 64 is formed with an access cutout 66 about halfway up the third leg. The third leg 64 tapers in a direction from the lower plate 42 to the upper edge of the post 52. The post 52 also includes a very short rib 68 that projects forward from the inner edge 62 of the first leg 52, in a direction away from the second leg 60, within the phone space 53.

The third legs 64 of the posts 52 face each other across the phone space 53. The two third legs 64, together with the front surfaces 56 of the two first legs 54, define the side and back boundaries of the phone receiving space 53 of the holder 10.

The base 40 includes a cross plate 70 that extends between and interconnects the two posts 52. The cross plate 70 is generally co-planar with the first legs 54 of the posts 52. The cross plate 70 partially defines the back boundary of the phone space 53 of the holder. The cross plate 70 has a lower edge 72 that is spaced upward from the lower plate 42 by a small amount, and an upper edge 74 that is located about two thirds of the way up the length of the posts 52. Another very short rib 76 projects forward from the cross plate 70, at a laterally central location on the cross plate.

The base 40 includes two sets of ratchet teeth 78, one set on each one of the two posts 52. The ratchet teeth 78 are located behind the cross plate 70, on the inner side surfaces of the second legs 60. Thus, the two sets of teeth 78 face inward toward each other. In the illustrated embodiment, each set of ratchet teeth 78 extends vertically for substantially the entire height of the cross plate 70. The ratchet teeth 78 are oriented to allow downward movement of a pawl along the ratchet teeth, but block upward movement of a pawl along the ratchet teeth.

The slider 80 includes a central plate 82. Four arms 84 extend out from the central plate 82, two on each side. Each arm 84 has a hook-shaped configuration when viewed from above, including an end portion 86 that wraps around back toward the central plate 82. The dimensions of the arms 84 are such their end portions 86 can engage and wrap around the outer edges 66 of the first legs 54 of the posts 52 of the base 40, to support the slider 80 for vertical sliding movement along the posts, in a manner as described below, to clamp different height phones.

The slider 80 includes a top plate 88 that extends forward from the upper edge of the central plate 82. A retaining lip 89 extends downward from the front edge of the top plate 88 of the slider 80. The slider 80 also includes two pawls 90 for engagement with the ratchet teeth 78 on the base 40. Each one of the pawls 90 is located on a resilient pawl arm 92 that is adjacent to the central plate 82 of the slider 80. On the pawl arms 92, the pawls 90 are located forward of the central plate 82. On the pawl arms 92, there are also included gripper portions 94 that are located behind the central plate 82. The two gripper portions 94 are adapted to be squeezed together by a thumb and finger of a user's hand. Moving the two gripper portions 94 toward each other results in movement of the pawls 92 inward, toward each other, away from the ratchet teeth 78. When the two gripper portions 94 are released, the resiliency of the pawl arms 92 returns them to their free state in which the pawls 90 are moved laterally outward, away from each other and toward the ratchet teeth 78.

In assembling the holder 10, the base 40 is assembled to the mount 20 in what may be a semi-permanent connection. The locking pin 44 of the base 40 is engaged in the pin opening 28 of the mount 20. This engagement not only blocks removal of the base 40 from the mount 20, but also enables rotation of the base relative to the mount, about the locking pin 44. This rotation is limited by the stops 48 on the base 40 that engage the stop elements 32 on the mount 20 at the ends of the range of rotational motion, which is typically about 90 degrees. If this rotational movement is not needed, the base 40 and mount 20 could be made as one piece, not as two separate pieces.

The rotational position of the base 40 on the mount 10 is also controlled by selective engagement of the two detent pins 50 on the base, with the detent recesses 30 in the mount. The base 40 and mount 20 are preferably configured to provide five detented locking positions over the range of motion. This range of motion allows the user to orient the phone 100 angularly on the handlebar 12, so that the user can see the phone clearly. This range of motion can also be maintained with a permanent connection of the base 40 to the mount 20.

The slider 80 is preferably assembled to the base 40, before capturing the phone 100 in the clamp assembly 81. Specifically, the slider 80 is positioned over the upper edge of the base 40, and slid downward onto and along the posts 52. The four arms 84 on the slider 80 engage around the two posts 52 on the base 40, with the hooked end portions 86 wrapping around the first legs 54 of the posts, to position the slider on the base for vertical sliding movement along the posts.

When the slider 80 is then slid far enough down the posts 52, the pawls 90 on the slider engage the ratchet teeth 78 on the base 40. The resilience of the pawl arms 92 allows the pawls 90 to slide over the ratchet teeth 78. The pawls 90 are configured to engage the ratchet teeth 78 in a manner to allow downward sliding movement of the slider 80 toward the bottom of the base 40, but resist upward sliding movement of the slider off the base.

The phone 100 can then be positioned in the phone receiving space 53 on the base 40. Alternatively, the phone 100 may be positioned in the phone space 53 before the slider 80 is engaged with the base 40. The bottom 102 of the phone 100 rests on the lower plate 42 of the base 40, and the sides 104 of the phone are located adjacent to and between the third legs 64 of the posts 52.

Once the phone 100 is in position, the slider 80 is slid down until its top plate 98 engages the top 106 of the phone. The phone 100 is thus releasably captured between the top plate 88 of the slider 80 and the lower plate 42 of the base 40. Because the pawls 90 are engaged with the ratchet teeth 78, the slider 80 can not inadvertently be moved upward to release the phone 100 vertically. As a result, vertical movement of the phone 100 on the base 40 is prevented.

This gripping or clamping of the phone vertically, between the slider 80 and the base 40, provides a “universal” feature for the holder 10. That is, the holder 10 can grip cell phones or other devices of multiple different sizes and heights. The ability of the slider 80 to create a secure fit on all different height devices, against the base 40, provides this capability.

The retaining lip 89 on the top plate 88 of the slider 80 prevents the top 106 of the phone 100 from moving forward, out of the holder 10. The lip 46 on the lower plate 42 of the base 40 prevents the bottom 102 of the phone 100 from moving forward, out of the holder 10.

The back of the phone 100 rests against the ribs 68 and 76 on the base 40. As a result, forward or rearward movement of the phone 100 on the base 40 is prevented. The sides 104 of the phone 100 are located adjacent to, and inward of, the third legs 64 of the posts 52. As a result, lateral movement of the phone 100 on the base 40 is prevented. The phone 100 is thus securely captured on the holder 100 and prevented from unintentional removal.

To remove the phone 100, the gripper portions 94 of the pawl arms 92 are engaged and squeezed inward toward each other. This action moves the two pawls 90 laterally inward, out of engagement with the ratchet teeth 78. The slider 80 can then be moved upward along the posts 52, freeing the phone 100 for removal from the holder 10.

Some phones have a clip on the back for holding the phone. In this case, the slider 80 can be removed completely from the base 40, and the phone clip can be clipped onto the cross plate 70 of the base 40, to secure the phone 100 to the base.

The dimensions of the holder 100, including the base 40 and the slider 80, are selected to accommodate the tallest phone on the market. However, if a taller phone is provided, the posts 52 are long enough to move the slider 80 upward and still secure the phone 100 even though a portion of the slider might be slightly off the base 40. Inserts of foam or other material may be provided to help grip the phone better.

1. A holder for holding a phone on a support structure such as a handlebar of a stroller, comprising:
a mount for releasable connection with the support structure;
a base supported on the mount for receiving and supporting the phone; and
a slider supported on the base for sliding movement relative to the base between a first position enabling removal of the phone from the holder and at least one clamping position blocking removal of the phone from the holder.

2. A holder as set forth in claim 1 wherein the base has a portion that engages the bottom of the phone when the phone is in position on the holder and the slider has a portion that engages the top of the phone when the phone is in position on the holder, thereby to block vertical movement of the phone on the holder.

3. A holder as set forth in claim 2 wherein the slider is adjustable on the base between a plurality of different clamping positions blocking removal of the phone from the holder, to accommodate different height phones.

4. A holder as set forth in claim 1 including a pawl and ratchet mechanism for adjustably controlling the position of the slider on the base.

5. A holder as set forth in claim 1 wherein the base is supported on the mount for rotational movement relative to the mount between a plurality of rotational positions.

6. A holder as set forth in claim 1 wherein the slider is adjustable on the base between a plurality of different clamping positions blocking removal of the phone from the holder, the holder including a pawl and ratchet mechanism for adjustably controlling the position of the slider on the base, and wherein the base is supported on the mount for rotational movement relative to the mount between a plurality of rotational positions.

7. A holder as set forth in claim 6 wherein the mount has a curved configuration adapted to engage a curved outer surface of the support structure and also has an adjustable strap for releasably securing the mount to the support structure.

8. A holder as set forth in claim 6 wherein the base includes a laterally centrally located plate configured to receive a clip of a phone for holding the phone on the base without the slider.

9. A holder for holding a cell phone on a support structure such as a handlebar of a stroller, comprising:
a clamping assembly for clamping the phone, the clamping assembly including two separable pieces that can be releasably joined in an adjustable locking relationship to clamp the phone between them; and
a mount connected with the clamping assembly for mounting the clamping assembly on the support structure.

10. A holder as set forth in claim 9 wherein the clamping assembly includes a base and a slider, the slider being slidable between a plurality of different clamping positions on the base.

11. A holder as set forth in claim 10 including a pawl and ratchet mechanism for adjustably controlling the position of the slider on the base.
